(19) United States
(12) Patent Application Publication
(10) Pub. No.: US 2026/0098632 A1
(43) Pub. Date: Apr. 9, 2026

(54) Sleep Aid Device for Children

(71) Applicant: heyaxa products INC, ANAHEIM, CA (US)

(72) Inventor: Lei XIA, ANAHEIM, CA (US)

(73) Assignee: heyaxa products INC, ANAHEIM, CA (US)

(21) Appl. No.: 19/417,647

(22) Filed: Dec. 12, 2025

Related U.S. Application Data
(63) Continuation of application No. 18/770,660, filed on Jul. 12, 2024.

(51) Int. Cl. F21V 23/04; F21V 15/01; F21V 23/02; F21V 23/06; H04R 1/02; H04R 3/00

(52) U.S. Cl. CPC F21V 23/0435; F21V 15/01; F21V 23/023; F21V 23/0485; F21V 23/06; H04R 1/025; H04R 1/028; H04R 3/00; H04R 2420/07

(57) ABSTRACT

A sleep aid device for children includes at least one collection terminal for acquiring data related to a child's state, including at least one of voice, images, movements, environmental information, physiological signals, and/or instructions input from external devices; a data processing module for transmitting, preprocessing, and/or formatting the data; and a content generation module for generating personalized content based on the child's state data, used for emotional soothing and interactive companionship.

### CROSS-REFERENCE TO RELATED APPLICATIONS

This application is a continuation-in-part of the application titled “Sleep Aid Device for Children” filed on Jul. 12, 2024, with a filing number of U.S. Ser. No. 18/770,660, the content of which is incorporated herein by reference in its entirety.

### TECHNICAL FIELD

The present invention relates to the technical field of children's sleeping instruments, in particular to a sleep aid device for children.

### BACKGROUND

The traditional sleeping instrument usually consists of two main parts: the top is the speaker of the sleeping instrument, and the middle or bottom is the lamp. This design makes the lamp body and the speaker integrate into one structure, which combines the functions of music playing and lighting. At night, children can fall asleep with the sleeping instrument. At the same time, the sleeping instrument can also play children's favorite music and let them enjoy soft light, thus creating a quiet and comfortable sleeping environment and enabling children to fall asleep more stably.

U.S. Patent No. US20230091548A1 discloses “MULTIFUNCTION SLEEP TRAINING DEVICE WITH REMOTE LOCKING MECHANISM AND METHODS OF OPERATION THEREOF”, which is a structure in which a lamp body and a speaker are integrated. Therefore, when a child sleeps with the sleeping instrument, the speaker will be too close to the child's ear, which will affect the child's sleep quality, and placing the speaker near the ear for a long time, especially when playing a large volume, may have a negative impact on the child's hearing.

Therefore, it is necessary to put forward a new type of children's sleeping instrument. The children sleep lamp body of this new type can be detached and placed beside children, so that the speaker is far away from children, so as to avoid affecting children's sleeping quality and hearing.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a sleep aid device for children, aiming at sol that problem that the existing children's sleep instrument is integrally provided with a speaker and a lamp body, which affects the sleep quality and hear of children.

In order to achieve the above purpose, the present invention adopts the following technical solutions:
A sleep aid device for children includes a lamp body and a base; a first circuit board and a second circuit board are respectively arranged in the lamp body and the base; and
the first circuit board and the second circuit board are both provided with a single chip microcomputer and a Bluetooth control module for wireless connection with a mobile phone; and
the lamp body and the base are separately arranged, and an audio playing component is arranged in the base; and
the lamp body comprises a lampshade and a bottom plate, wherein the bottom plate is arranged on the lampshade and faces the base, and at least one first magnet is arranged on one side of the bottom plate located inside the lampshade; and
the base comprises a shell, one surface of the shell is set as a mating surface for connecting and mating with the bottom plate, at least a second magnet is installed inside the shell, and the second magnet is attracted to the first magnet with the mating surface and the bottom plate therebetween.

A sleep aid device for children includes a lamp body and a base; the lamp body and the base are detachably connected; and
an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server.

A sleep aid device for children includes a lamp body and a base; at least one base is provided, and one or more lamp bodies are provided; and
the base is detachably connected with one or more lamp bodies;
an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server.

A sleep aid device for children includes a lamp body and a base; the lamp body is installed on the base, and an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server; and
the first circuit board is further provided with a voice control module and a sensor lamp; and
wherein, the voice control module is used for monitoring an ambient volume, and when the ambient volume exceeds a preset value, the single chip microcomputer executes a preset program.

A sleep aid device for children includes a lamp body and a base; the lamp body is installed on the base, and an audio playing component is arranged in the base for playing preset audio;
a first circuit board and a second circuit board are respectively arranged in the lamp body and the base; and
the first circuit board and the second circuit board are both provided with a single chip microcomputer, a Bluetooth control module for wireless connection with a mobile phone and a WIFI module for connection with a server; and
the first circuit board or the second circuit board is further provided with a camera monitoring module and a sensor lamp; and
wherein, the camera monitoring module is used for monitoring a sleeping state of a child, and when it is monitored that the child wakes up within a preset time, the single chip microcomputer executes a preset program.

A sleep aid method for children includes adopting a sleep aid device for children, which comprises a lamp body and a base, wherein the lamp body and the base are detachably connected; a first circuit board and a second circuit board are respectively arranged in the lamp body and the base; the first circuit board and the second circuit board are both provided with a single chip microcomputer and a Bluetooth control module for wireless connection with a mobile phone; a voice control module and a sensor lamp are also installed on the first circuit board; and an audio playing component is arranged in the base; an outer surface of the shell is provided with a plurality of control buttons electrically connected with the second circuit board;
the method includes the following steps:
Step 1, pressing a control button to start the sleep aid device;
Step 2, using the Bluetooth function of the mobile phone to connect to the sleep aid device;
Step 3, setting a sleep plan on a mobile phone APP;
Step 4, the sleep aid device executing a sleep aid planning program;
Step 5, separating the lamp body from the base, or separating before the sleep program is executed;
Step 6, placing the lamp body beside a child to aid sleeping, and placing the base at a certain distance away from the child;
Step 7, when the child wakes up and cries, the voice control module monitoring a crying sound, and the single chip microcomputer automatically executing a preset audio and playing e the preset audio through the speaker to coax the child to continue sleeping.

A sleep aid device for children includes at least one collection terminal for acquiring data related to a child's state, wherein the data comprises at least one of voice, images, movements, environmental information, physiological signals, and/or instructions input from an external device; a data processing module configured to transmit, preprocess, and/or format the data; a content generation module configured to generate personalized content based on the data related to the child's state, wherein the personalized content is configured for emotional soothing, interactive companionship, and/or sleep assistance; and an output terminal configured to deliver the personalized content in at least one form of audio, images, light effects, vibrations, and/or other human-machine interaction methods. The content generation module can be deployed on the collection terminal, an output terminal or a remote server, and the system supports operation in online or offline modes.

A sleep aid device for children includes at least one collection terminal configured to obtain data related to behavior, emotions, and/or physiological states of a child, wherein the data comprises at least one of voice, images, movements, environmental information, physiological signals and/or instructions input from an external device; a data processing module configured to transmit, preprocess, and/or format the data; a content generation module configured to generate personalized content based on data related to the states of the child for emotional soothing, interactive companionship, and/or sleep assistance; a voice output control module configured to convert personalized content into speech with corresponding character voices based on a parental voice feature model, an authorized person voice feature model, and/or an AI-generated voice feature model; and an output terminal configured to output the personalized content in at least one form of audio, images, light effects, vibration, and/or other human-computer interaction methods. The content generation module and the voice output control module can be deployed at any position of the collection terminal, the output terminal or a remote server, and a system supports operation in online and/or offline modes.

A sleep aid device for children includes a voice sample reception module configured to collect voice samples of at least one specified user or an authorized individual; a voice feature model generation module configured to generate a voice feature model corresponding to the individual based on the voice samples; a user state information acquisition module configured to obtain feature information or instructions related to states of a child based on voice input, behavioral events and/or external input of the child; a content generation module configured to generate personalized content for child emotional soothing, interactive companionship, and/or sleep assistance based on the feature information or instructions; voice output module configured to convert the personalized content into speech in a voice of the corresponding individual based on the voice feature model; and an output terminal configured to output the personalized content in audio and/or other human-computer interaction forms. The voice feature model generation module and the content generation module can be deployed at any position of the collection terminal, the output terminal or a remote server, and a system supports operation in online or offline modes.

A sleep aid device for children includes a voice feature model storage module configured to store at least one voice feature model associated with virtual characters, authorized persons and/or AI-generated characters; a user state information acquisition module configured to acquire feature information or instructions related to states of a child based on voice input, behavioral events and/or external input of the child; a content generation module configured to generate personalized content for emotional soothing, interactive companionship, and/or sleep assistance based on the feature information or instructions; a voice output module configured to convert the personalized content into voice output corresponding to character voices based on the voice feature model; and an output terminal configured to output the personalized content in audio and/or other human-machine interaction forms. The content generation module and the voice output module can be deployed at any position of the acquisition terminal, the output terminal or a remote server, and a system supports operation in online or offline modes.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic structural diagram of the whole invention.

FIG. 2 is a schematic structural view of the lamp body of the present invention.

FIG. 3 is an exploded view of the lamp body of the present invention.

FIG. 4 is a schematic structural diagram of the base of the present invention.

FIG. 5 is an exploded view of the base of the present invention.

FIG. 6 is a control schematic diagram of the present invention.

In the figures: Lamp body (100); Lampshade (101); Bottom plate (102); First circuit board (103); First connector (104); Power module (105); First magnet (106); Light-emitting element (107); Base (200); Shell (201); Second connector (202); Control button (203); Foot pad (204); Sound outlet hole (205); Speaker (206); Second circuit board (207); Second magnet (208); Mating surface (209); Single chip microcomputer (301); WIFI module (302); First antenna (303); Audio amplifier (304); Voice control module (305); Sensor lamp (306); Second antenna (307); Bluetooth control module (309); USB interface (310).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

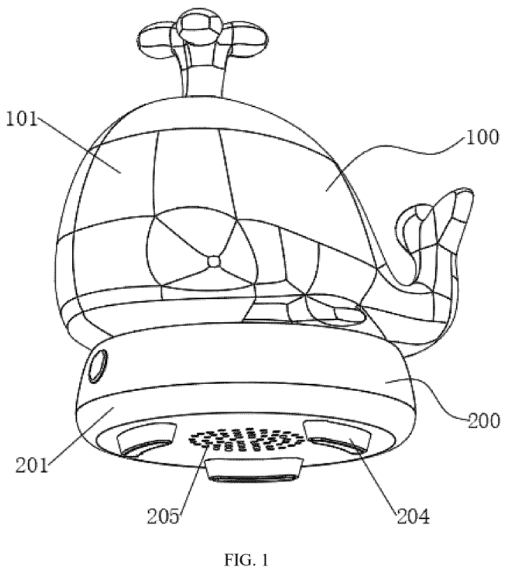

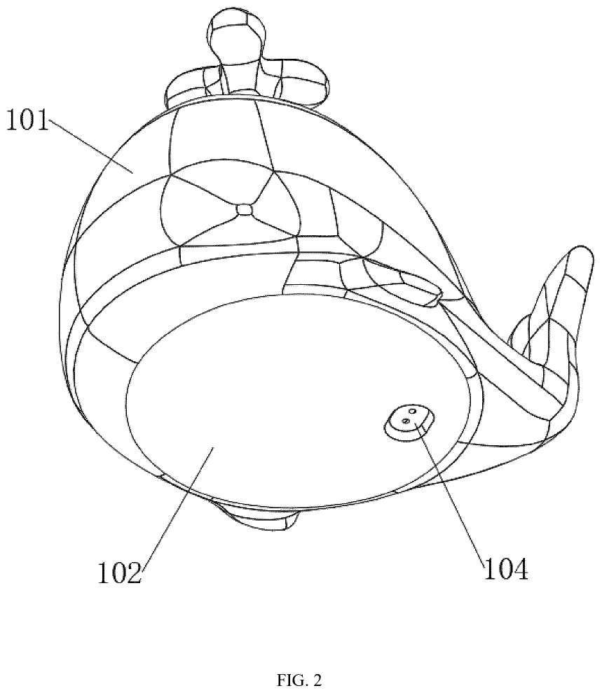

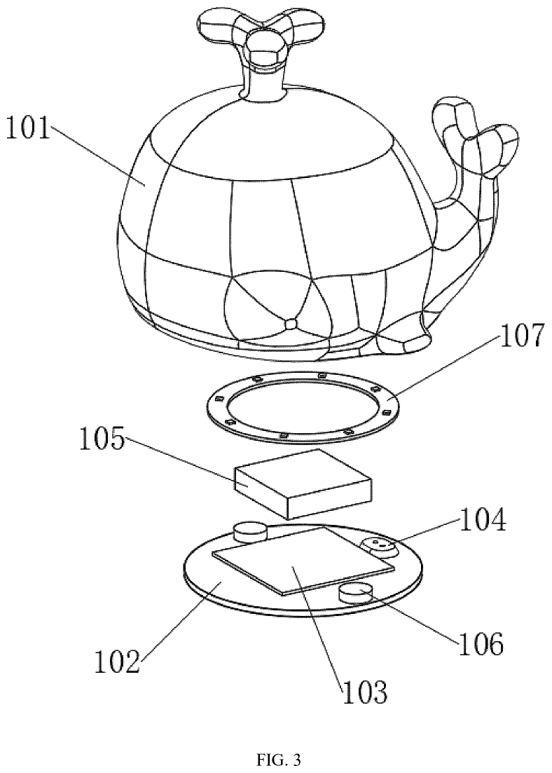

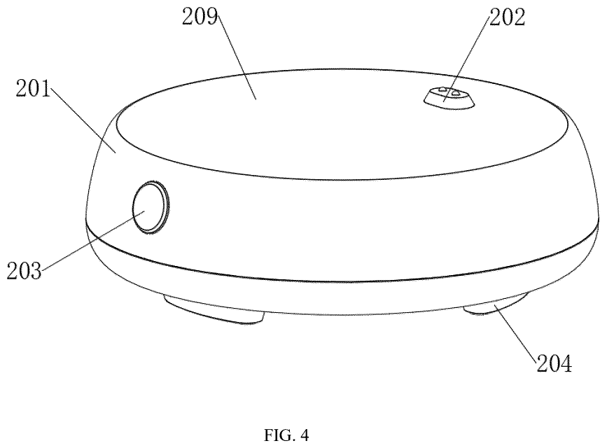

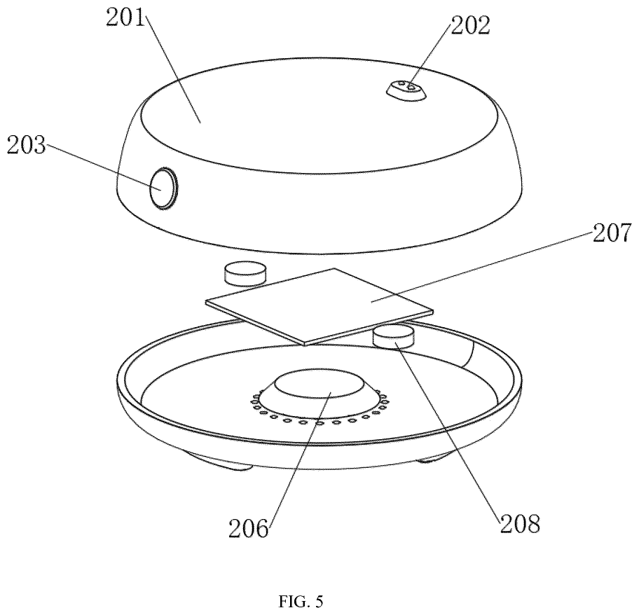

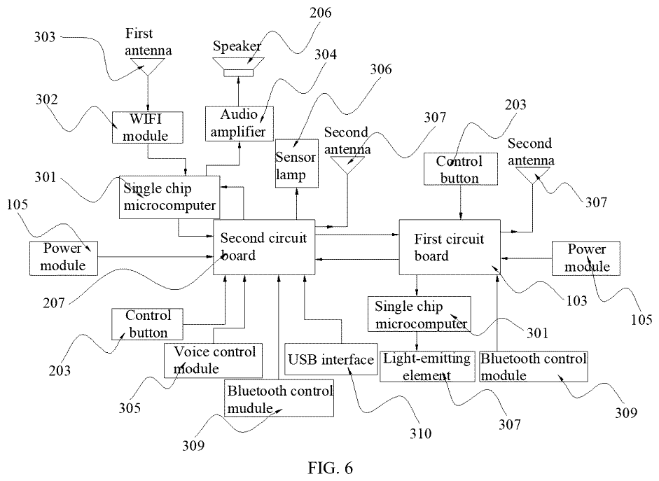

Please refer to FIG. 1 to FIG. 6;

### EXAMPLE 1

The present invention provides a sleep aid device for children, which includes a lamp body 100 and a base 200, wherein a first circuit board 103 and a second circuit board 207 are respectively arranged in the lamp body 100 and the base 200; a single chip microcomputer 301 and a Bluetooth control module 309 for wireless connection with a mobile phone are arranged on the first circuit board 103 and the second circuit board 207; the lamp body 100 and the base 200 are separately arranged; and an audio playing component is arranged in the base 200.

In this embodiment, the first circuit board 103 and the second circuit board 207 can be matched and connected with the mobile phone through the Bluetooth control module 309, so that the base 200 and the lamp body 100 can be independently connected with the mobile phone, and then the lamp body 100 and the base 200 can be independently controlled through the mobile phone APP.

In other embodiments, the first circuit board 103 and the second circuit board 207 can be automatically matched and connected through Bluetooth connection, so that when a mobile phone is connected to a single lamp body 100 or the base 200, the lamp body 100 and the base 200 can be automatically matched and connected, thereby enabling data transmission between the lamp body 100 and the base 200.

The lamp body 100 includes a lampshade 101 and a bottom plate 102, wherein the bottom plate 102 is installed on the lampshade 101 and faces the base 200; at least one first magnet 106 is installed on one side of the bottom plate 102 located in the lampshade 101; the base 200 includes a shell 201; one surface of the shell 201 is set as a matching surface 209 for connecting and matching with the bottom plate 102; at least one second magnet 208 is installed inside the shell 201; the second magnet 208 is attracted to the first magnet 106 with the mating surface 209 and the bottom plate 102 therebetween. The first circuit board 103 is installed on the bottom plate 102 and staggered with the first magnet 106. The second circuit board 207 is installed on the inner surface of the shell 201 and staggered with the second magnet 208. One surface of the shell 201 is set as the mating surface 209 for connection and mating with the bottom plate 102.

In this embodiment, the first magnet 106 and the second magnet 208 are both magnets, so that when the bottom plate 102 is close to the mating surface 209 of the shell 201, the first magnet 106 and the second magnet 208 are attracted to each other being spaced by the shell 201 and the bottom plate 102, thereby quickly and firmly connecting the lamp body 100 with the lampshade 101. This structure not only simplifies the connection process, but also makes the separation between the lamp body 100 and the lampshade 101 equally convenient.

In other embodiments, one of the first magnet 106 and the second magnet 208 is a magnet and the other is a ferromagnetic material, so that attraction can also be achieved.

A power module 105 is also installed on the first circuit board 103, and at least one light-emitting element 107 electrically connected with the first circuit board 103 is installed in the lampshade 101. A side of the bottom plate 102 facing the base 200 is equipped with a first connector 104 which is electrically connected with the first circuit board 103; a second connector 202 connected with the first connector 104 is installed on the mating surface 209, and the second connector 202 is electrically connected to the second circuit board 207.

In this embodiment, the power module 105 is a storage battery, which can provide power for the first circuit board 103 and related modules. When the lamp body 100 and the base 200 are connected, the second connector 202 will be inserted into the first connector 104, so that the first circuit board 103 will be conducted with the second circuit board 207 through the connection of the first connector 104 and the second connector 202, and the battery can also supply power to the second circuit board 207 and related modules.

In this embodiment, the light-emitting element 107 is an LED circuit board, on which a plurality of lamp beads are mounted to provide a bright and uniform light source. As a stable power supply, battery can provide continuous power support for LED circuit boards. Furthermore, the single chip microcomputer 301 on the first circuit board 103 plays a core control role, which can accurately adjust the brightness and color of the light beads on the LED circuit board, bringing rich and varied lighting experiences to users. This not only ensures the stability and reliability of the light source, but also greatly improves the flexibility and convenience of use.

The audio playing component includes a speaker 206 and an audio amplifier 304. The speaker 206 is installed on the inner surface of the shell 201 and electrically connected with the second circuit board 207. The outer surface of the shell 201 is provided with a plurality of sound outlet holes 205 corresponding to the speaker 206. The audio amplifier 304 is installed on the second circuit board 207 for amplifying the electric signal input to the speaker 206.

Audio is preset in the single chip microcomputer 301. When the sleep aid program is executed, the single chip microcomputer 301 automatically executes the preset audio, which is transmitted to the speaker 206 through the audio amplifier 304 and played out. The preset audio includes white noise, children's parents'voices and so on.

Moreover, when the mobile phone is connected with the sleep aid device by Bluetooth, the base 200 is equivalent to a Bluetooth speaker, and the audio in the mobile phone can be played through the mobile phone APP or required audio is recorded on the mobile phone APP and played, and the timbre of the children's parents can be recorded through the mobile phone APP, and then the audio that comforts the children can be played through AI combined with the timbre of the children's parents.

In other embodiments (not shown), the lamp body 100 and audio soothing responses are activated through AI recognition of a child's crying, turning over, body movements, thermal sensations, and other states.

In other embodiments (not shown), a model is trained via AI or big data to establish an “optimal sleep rhythm pattern” based on age groups, and dynamic adjustment is performed through a combination of lighting and audio.

In other embodiments (not shown), a mobile app can simultaneously connect multiple lamp bodies 100 and bases 200, suitable for use in multi-child households.

In other embodiments (not shown), in the child sleep assistance device, sleep program content is pre-downloaded and locally stored via an app, executed independently by the device to avoid program interruption or lag due to network outages. The use of the sleep program includes the following steps: setting a sleep program via a client mobile device, including audio, lighting, and control instructions; downloading the sleep program content wirelessly to the local storage module of the sleep aid device for children; at user-set time points or when trigger conditions are met, reading the program content from local storage by the device's local processor; executing tasks such as audio playback and lighting control in a preset sequence; the execution process does not rely on real-time communication with a server.

According to the above, the WIFI module 302 is also installed on the second circuit board 207, and the first antenna 303 is installed on the WIFI module 302. The second circuit board 207 is connected with the USB interface 310 through wires, and the USB interface 310 penetrates the outer surface of the shell 201. A plurality of control buttons 203 electrically connected with the second circuit board 207 are installed on the outer surface of the shell 201, and the foot pad 204 for supporting the base 200 is installed at the bottom of the shell 201.

In this embodiment, the base 200 is combined with the WIFI module 302 through the built-in 2.4G antenna, which realizes stable connection with the wireless network and provides users with convenient remote control and intelligent management functions. In addition, in order to facilitate the user to charge the equipment, the base 200 is also equipped with a 5V USB interface 310. The user only needs to connect an external power supply to the USB interface 310, and when the lamp body 100 is connected to the base 200, the power module 105 can be charged, thus ensuring the continuous and stable operation of the equipment.

In other embodiments, the wireless charging module can be used as the power module 105. This embodiment not only simplifies the charging process, but also improves the user experience. Users only need to put the lamp body 100 on the wireless charging base, and can charge the lamp body 100 through wireless charging without complicated cable connection, thus realizing real convenience and high efficiency.

The control button 203 is a mechanical switch or a touch switch, so the user can easily control the base 200 through the physical operation of the mechanical switch or the touch of the touch switch, and a plurality of control buttons 203 are arranged, so that each control button 203 has different functions, such as turning on or off the sleep aid device, unlocking the sleep aid device, and adjusting the light and volume. And when the base 200 and the lamp body 100 are successfully connected, the function of this control button 203 is extended due to the conduction structure between them, which can not only control various functions of the base 200, but also directly control the lamp body 100. This design not only improves the user experience, but also increases the intelligence of the equipment.

In other embodiments (not shown), a small projection module (e.g., a micro DLP or LCoS projection engine) is added inside the lamp body 100, installed at the top or side of the inner surface of the lampshade 101. This module is electrically connected to the first circuit board 103. The memory on the first circuit board 103 (or cloud storage connected via the WIFI module 302) stores various static starry sky patterns, dynamic story scenes (e.g., slowly moving clouds, stars, story character silhouettes), or soothing dynamic light effects (e.g., slowly changing water ripples). Users can select projection content, adjust projection brightness/focus (if auto-focus is supported), and set projection timers via a mobile app. The control button 203 can also be preset for projection on/off or mode switching. Projection content can synchronize with audio stories played by the base 200, such as projecting underwater light effects when playing ocean stories, enhancing immersion.

In other embodiments (not shown), the base 200 is internally provided with a ring array of 4 sets of electromagnets (replacing the second magnet 208), connected to a dynamic balance controller (integrated into the second circuit board 207). The bottom of the lamp body 100 is embedded with a permanent magnet array (replacing the first magnet 106), where the polarity distribution of the permanent magnets corresponds to the electromagnets to form a repulsive force field. The mating surface 209 of the base 200 incorporates a Hall sensor array to monitor the suspension height and tilt angle of the lamp body 100 in real time.

In other embodiments (not shown), the lampshade 101 includes a shaped shell, a light-guiding layer, and an embedded identification module. Specifically: the shaped shell takes the form of cartoon characters, animals, or geometric patterns; the light-guiding layer is made of light-diffusing material to guide the light emitted by the internal light source for specific visual effects; the identification module transmits character ID information to the device processor when the lampshade 101 is installed on the device; upon receiving the character ID, the processor drives the light color, brightness, rhythm, and sound effects to synchronize with the character theme based on preset data; the lampshade 101 is connected to the lamp body 100 via snap-fit, magnetic, or twist-lock mechanisms, allowing users to freely replace it; the structure supports multiple lampshade 101 designs for universal use on the same base 200 platform.

### EXAMPLE 2

A sleep aid device for children includes a lamp body 100 and a base 200, wherein the lamp body 100 and the base 200 are detachably connected; an audio playing component is arranged in the base 200 for playing preset audio; a first circuit board 103 and a second circuit board 207 are respectively arranged in the lamp body 100 and the base 200; a single chip microcomputer 301 and a Bluetooth control module for wireless connection WIFI a mobile phone are installed on the first circuit board 103 and the second circuit board 207.

The difference between Example 2 and Example 1 is that:

The lamp body 100 and the base 200 can be connected by detachable connection modes such as clamping, threaded connection and the like. The first circuit board 103 is further provided with a voice control module 305 and a sensor lamp 306. The voice control module 305 is used for monitoring the ambient volume, and the sensor lamp 306 is automatically turned on when the ambient volume exceeds a preset value. The first circuit board 103 and the second circuit board 207 are both provided with a second antenna 307 for data transmission between the first circuit board 103, the second circuit board 207 and the mobile phone.

The voice control module 305 can monitor the ambient volume, and can monitor the ambient volume in real time and compare it with the preset sound decibel value. Once the monitored decibel value exceeds the preset value, the voice control module 305 will automatically start the sensor lamp 306 to provide users with real-time lighting services, and at the same time, the single chip microcomputer 301 will automatically play the preset audio or adjust the light of the lamp body 100. This method not only improves the intelligent level of the equipment, but also brings users a more convenient experience.

By setting the second antenna 307, when the mobile phone is connected with the second circuit board 207 through the wireless network, the first circuit board 103 and the second circuit board 207 can be wirelessly connected through the two second antennas 307, thereby realizing wireless data transmission among the base 200, the lamp body 100 and the mobile phone. This method not only expands the functional scope of the equipment, but also provides users with more diverse usage scenarios.

In other embodiments (not shown), the lamp body 100 is designed as a compact, lightweight standalone unit, with shapes such as spherical or small animal figures. Its shell (similar to the lampshade 101) is made of soft silicone or fabric and integrates a hanging hole or detachable clip/strap.

Inside the compact lamp body 100, the following components are highly integrated: the first circuit board 103 (including a single chip microcomputer 301, a Bluetooth control module 309, and a small-capacity power module 105 such as a button cell or small lithium battery); a miniature light-emitting element 107 (e.g., single or multiple small LEDs); optionally, a miniature speaker 206 (for basic audio playback functions like white noise or simple melodies) or only the voice control module 305 (for detecting cries to trigger light changes).

This portable lamp body 100 can operate entirely without relying on the base 200. It can also be clipped to a crib railing, hung by the bedside, held or worn by children as a soothing toy (e.g., around the neck or wrist, ensuring absolute safety), or carried during travel.

In other embodiments (not shown), this sleep aid device for children can also be used in outdoor tent scenarios. The outdoor tent is integrated with a blackout tent, rhythmic lighting module, smart sleep device, and audio content control system into a unified immersive sleep aid system for children, providing synergistic effects of rhythm guidance, automatic soothing, environmental isolation, and content companionship.

The sleep aid system includes: a blackout tent body, structurally made of enclosed flexible light-blocking material, equipped with ventilation windows and a main device placement area; a rhythmic lighting module, built into the top or sidewalls of the tent, supporting brightness, color temperature, and gradient control, with lighting parameters synchronized to a rhythm model; a smart sleep device host, which can be fixed to the tent via magnetic or slot attachment, featuring functions such as audio playback, rhythm trigger control, and AI content output; an audio output module, playing AI stories, parental voices, or rhythmic sound effects in sync with the lighting; an App control platform, allowing users to set rhythm plans, story content, and light-effect linkage modes via smartphone; and an environmental detection module, which senses children's nighttime movements, sounds, or changes in temperature/humidity, automatically triggering rhythm reset and soothing content. Compared to traditional tents or standalone sleep devices, it provides a fully enclosed immersive rhythmic sleep space; synchronized light and audio output creates a complete rhythmic beat guidance process; all modules can be linked and controlled via the App to match the baby's sleep-wake rhythm; the system supports parental voice story uploads and AI synthesis to enhance emotional companionship; the system can automatically respond to a baby's nighttime awakenings, improving nighttime soothing capabilities.

### EXAMPLE 3

The difference between Embodiment 3 and Embodiment 2 is that there is at least one base 200 and one or more lamp bodies 100. The base 200 is detachably connected WIFI one or more lamp bodies 100, and an audio playing component is arranged in the base 200 for playing preset audio. The first circuit board 103 and the second circuit board 207 are respectively arranged in the lamp bodies 100 and the base 200, and the first circuit board 103 and the second circuit board 207 are both equipped with a single chip microcomputer 301, a Bluetooth control module 309 for wireless connection with a mobile phone, and a WIFI module 302 for connection with a server.

The Bluetooth control module 309 of the base 200 can be matched and connected with the mobile phone, while a plurality of lamp bodies 100 can be matched and connected with the base 200 through the Bluetooth control module 309, and a plurality of lamp bodies 100 are also matched and connected with each other through the Bluetooth control module 309. Therefore, in this way, when the mobile phone is connected with the base 200, all the lamp bodies 100 can be controlled.

Moreover, in this embodiment, a plurality of lamp bodies 100 can be detachably attached to the base 200, and at the same time, a plurality of lamp bodies 100 can also be detached from the base 200 and placed at required positions respectively.

Moreover, in this embodiment (not shown in the attached drawings), the layout of the audio playing component is not limited to the installation inside the base 200. In fact, the audio playing component can also be installed in the lamp body 100 by the technical means of Example 1, thus endowing the lamp body 100 with the function of audio playing in addition to lighting.

Therefore, in this way, the lamp body 100 with the audio playing component is placed in the required place, so that a more stereoscopic sound effect and an all-round lighting environment can be achieved, and sound and light can be prevented from emitting from one point, thus making the sleeping environment of children more comfortable.

Moreover, in this embodiment, the color and shape of each lamp body 100 are different, so in this way, the styles of the lamp bodies 100 can be replaced according to the children's favorite, so as to be combined into sleep aid devices with different styles, and the applicability of the sleep AIDS is improved.

In other embodiments (not shown), the lamp body 100 can mimic sunrise and sunset movements. The interior of the lamp body 100 contains multiple independently controllable light sources, with control methods including; dividing the lampshade 101 vertically into at least two light-zone regions; during preset wake-up or sleep periods, sequentially controlling the light sources in different zones to turn on or off in a gradient rhythm.

The light-zone control process includes color gradients, brightness increase/decrease, or color temperature transitions; this process simulates the light changes of sunrise or sunset in natural environments and supports both local control and remote App configuration.

In other embodiments (not shown), the sleep aid device includes a main unit structure: the main body integrates a speaker and a lamp, supporting rhythmic light adjustment and audio playback; the top features a doll interface area, including magnetic slots, conductive contact areas, optical recognition windows, etc. The doll structure includes a base component that is physically engaged with the top structure of the main unit; each pose (e.g., lying down, sitting, reading, raising hands, etc.) serves as an identity marker; optional integrated recognition elements (e.g., magnetic polarity, mechanical structure coding, optical markers, chip contacts, etc.); the doll can also be designed as a non-detachable fixed structure, molded integrally with the lamp body 100. Recognition and control module: the main chip detects signal changes upon doll insertion; based on recognition data, it matches the corresponding rhythmic scene content (e.g., playing white noise+orange light at night, or stories+natural light for a reading doll); such content can be preset via an app or automatically downloaded; the control output module synchronizes gradual light changes+audio playback. The doll and the lamp body can be connected via magnetic attraction, plug-in sockets, or snap-fit mechanisms; recognition methods include but are not limited to: bottom conductive sheet closed circuit, resistance recognition, optical coding recognition, pose image recognition, mechanical slot detection, etc.; the doll's head, expression, or posture can serve as recognition factors to trigger different rhythms/lighting/story content; a timing mechanism (e.g., auto shut-off) or character voice synthesis (e.g., AI mimicking a character's tone for storytelling) can be added; the doll may be also integrated with content storage chips (e.g., EEPROM) for the main unit to read and play. This achieves triple synchronization of speaker+lighting+replaceable dolls; without NFC or wireless sensing, the recognition method is safer and more stable; it provides an emotionally perceptive rhythmic experience (e.g., “lying pose” represents sleep mode); children can participate in rhythm setting through “placement” actions, enhancing ritual and habit formation; modular content licensing and character commercialization expansion are possible, with potential for IP collaboration.

For instance, a lying doll activates the nighttime sleep aid program, the doll is in a closed-eye, prone pose, and contact closure is recognized upon placement; the system controls the light to shift to orange soft glow+white noise playback; it also records sleep initiation time for rhythm statistics.

Additionally, a reading doll triggers a bedtime story mode, with a resistance tag integrated at its base; upon placement, ID=“reading character” is recognized, initiating story playback+natural light transition; an automatic voice reminder can prompt, “it's story time, please prepare to sleep.”

It should be noted that the doll in the structure is part of the design, integrally formed with the lamp body 100; each device corresponds to different characters, sounds, and rhythm logic, and can be used to create a series of products such as the “Heyaxa Character Family.”

In other embodiments (not shown), the sleep aid device internally includes a user terminal, a rhythm content platform, a sleep companion character system, and a recommendation matching engine. User terminal: collects user sleep behavior data, including sleep duration, bedtime, nighttime awakenings, user ratings, etc. Rhythm content platform: includes content from creators and platform-produced materials, structured with audio clips, light control parameters, and rhythm step settings. Sleep companion character system: users can select specific characters to participate in rhythm playback, with characters capable of continuous growth and forming interactive memories with users. Recommendation matching engine: matches rhythm profiles with content tags to recommend the most suitable rhythm content package for the user's current state. The system supports intelligent revenue sharing for creators, popularity rankings for rhythm packages, priority recommendations, and dynamic updates to user profiles. This enhances content adaptability and user retention in the sleep assistance system; builds a complete content ecosystem supporting creator contributions and commercialization; strengthens emotional connections between users and characters, improving continued usage rates; and supports multi-device synchronized playback and rhythm content sharing.

### EXAMPLE 4

The difference between Example 4 and Example 3 lies in that the lamp body 100 is installed on the base 200, and an audio playing component is arranged in the base 200 for playing preset audio, and the first circuit board 103 and the second circuit board 207 are respectively arranged in the lamp body 100 and the base 200, and a single chip microcomputer 301 and a Bluetooth control module 309 for wireless connection with a mobile phone are installed on both the first circuit board 103 and the second circuit board 207; the first circuit board 103 is further provided WIFI a voice control module 305 and a sensor lamp 306; the voice control module 305 is used for monitoring the ambient volume, and when the ambient volume exceeds a preset value, the single chip microcomputer 301 executes a preset program.

In this embodiment, the lamp body 100 and the base 200 can be connected in a non-detachable or detachable way, so that the sleep aid device for children also has the function of monitoring the ambient volume. When the ambient volume is greater than the preset value, the children's sleep aid device can automatically execute preset programs, such as playing preset audio and adjusting the lighting.

In other embodiments (not shown), additional environmental sensor modules (such as temperature and humidity sensors, light sensors, PM2.5 sensors) are integrated on the circuit board (first circuit board 103 or second circuit board 207) of the lamp body 100 or base 200 (or both). The single chip microcomputer 301 (on the circuit board detecting environmental data) executes preset adaptive programs based on sensor data:

If the temperature is too high/low or humidity is too low, an alert is pushed via the mobile app, or smart home devices (supported by WIFI module 302 with relevant protocols) are linked to automatically turn on/off the air conditioner or humidifier. Simultaneously, the light color temperature can be adjusted (e.g., warmer light in cold conditions) or specific soothing audio can be played (e.g., rain sounds in dry conditions).

The light sensor detects ambient light intensity; after a child falls asleep, if the environment is too bright, the light automatically dims to a lower level; if the environment is very dark, the light brightness is maintained or fine-tuned to the most comfortable sleep-inducing level.

When the PM2.5 sensor detects poor air quality, the app pushes a reminder to parents to ventilate the room.

Sensor data is uploaded to the cloud server via the WIFI module 302, allowing the mobile app to display historical environmental data trends, helping parents understand patterns in their child's sleep environment.

In other embodiments (not shown), an independent sealed chamber is added inside the base 200, containing: a water tank assembly: a detachable water tank (side-sliding design) with a capacity of 300 ml, featuring a transparent water level window; an atomizer: an ultrasonic atomizing disc (isolated from the circuit board for moisture protection); a humidity sensor: monitors ambient humidity in real-time (accuracy ±3% RH); a mist outlet: designed with an independent air duct, located on the side of the shell 201 to avoid interference with the sound waves of the speaker 206. The second circuit board 207 includes a newly added humidification driver module, which adjusts the atomization intensity via the single chip microcomputer 301; through a connected mobile app, users can set a target humidity range (40%-70% RH), enabling the device to operate automatically at a constant humidity. When the voice control module 305 detects a child coughing, it automatically increases the humidity to 65% RH; when the ambient humidity falls below 40% RH, the light flashes to remind users to add water.

In other embodiments (not shown), a smart sleep device composed of a lamp body 100 and a base 200 is installed with a flexible, customizable controllable light strip along walls or cribs. The light strip contains a third circuit board, which includes a Bluetooth/WiFi dual-mode communication module (interoperable with the main device protocol); multi-zone independently addressable RGB LED strings and magnetic patches (compatible with crib rails/wall installation); the smart sleep device and controllable light strip are centrally controlled via a mobile app to create an immersive light-accompaniment atmosphere, aiding infants/children in establishing sleep rhythms through synchronized audio playback. The light strip forms a 270° surrounding light field around the crib, eliminating glare stimulation from a single light source; when the smart sleep device plays lullabies, the light strip gradually breathes in sync with the sound wave frequency; when the voice control module 305 detects crying, the light strip automatically switches to a slow-flowing warm yellow light to enhance soothing immersion.

Among these, the app interface allows setting the following linkage parameters: rhythm synchronization: the light strip's color automatically transitions according to sleep stages (e.g., dark blue→warm yellow→lights off); sound-light linkage: light brightness/color is dynamically matched with audio playback rhythm (e.g., white noise ocean sounds correspond to blue wave light effects); timed scenes: a starry sky projection light effect is activated one hour before bedtime; zone control: the light strip is divided into a head soothing zone/foot monitoring zone for independent dimming.

### EXAMPLE 5

The difference between Example t 5 and Example 4 is that the first circuit board 103 or the second circuit board 207 is also equipped with a camera monitoring module and a sensor lamp 306 (not shown in the attached figure). In other embodiments, both the first circuit board 103 and the second circuit board 207 can also be provided with a camera monitoring module and a sensor lamp 306.

The camera monitoring module can shoot children and capture their active state. When children are in active state, it indicates that children have woken up. Therefore, when it is monitored that the child wakes up within the preset time, the single chip microcomputer 301 executes the preset program.

In other embodiments (not shown), the first circuit board 103 or the second circuit board 207 is also equipped with a processor and a sensor module. The sensor module collects signals of a child's behavior or state, including at least one of the following: crying, rolling movements, heart rate changes, sound decibel levels, or temperature and humidity. These signals are input into a local or cloud-based AI model for analysis to determine whether the child is in a non-sleeping state. When the AI model identifies that the child is in a non-sleeping state, the device's control module automatically executes a preset soothing procedure. The soothing procedure includes at least one of the following: playing soothing audio, activating gentle light changes, playing parental voice recordings, or simulating heartbeat sounds. The soothing procedure does not require manual triggering by the user and does not rely on real-time server commands.

In other embodiments (not shown), the first circuit board 103 or the second circuit board 207 is equipped with a processor and a sensor module. The processor receives sleep schedule parameters set by the user in a mobile application, including wake-up time, bedtime, schedule regularity, and execution cycle. Based on the set parameters, it automatically generates a light change sequence and audio playback program that match the child's circadian rhythm, including gradual dimming or brightening of light, white noise, or natural sound playback rhythm. The plan content is downloaded to the local storage module of the sleep aid device. During the preset bedtime period each day, it automatically initiates a gradual sleep-inducing routine and activates simulated wake-up lighting before the set wake-up time. The daily execution results are recorded and fed back to the app to evaluate the formation of the sleep rhythm and adjust subsequent rhythm plans. The entire process can operate without real-time network control and has local execution capability.

In other embodiments (not shown), the first circuit board 103 or the second circuit board 207 is equipped with a timbre modeling module, an image modeling module, a story content module, a multimodal synthesis module, a display/playback module, and a control system. Timbre modeling module is used to collect voice samples from users (e.g., parents, grandparents, authorized IP characters, etc.), extract voice feature parameters through AI modeling, and generate story narration voices via speech synthesis. Image modeling module is used to collect photos or videos uploaded by users and generate 2D or 3D character appearances through deep learning algorithms, including customizable facial features, motion characteristics, clothing styles, etc. Story content module includes a preset story library and user-defined upload functionality, supporting content generation based on character tone and style. Multimodal synthesis module integrates the output of timbre modeling and image modeling to produce synchronized audiovisual output. Display/playback module supports screen display, projection devices, or mobile applications to showcase the character's storytelling process. Control system is configurable for different story durations, character switching schedules, and child behavior-triggered logic. Through the setup of the timbre modeling module, image modeling module, story content module, multimodal synthesis module, display/playback module, and control system, comprehensive customization of characters, including voice and appearance, is achieved. It supports users uploading the voices and appearances of relatives to enhance a sense of real companionship; provides IP character integration capabilities, enabling commercial character licensing collaborations; can be expanded into interactive bedtime experiences, such as gesture-triggered or night-waking replay functions; and generates content locally to avoid privacy leaks.

In other embodiments (not shown), the sleep aid device for children internally includes a host module, a character doll module, an AI speech synthesis module, a content management module, and a pairing and APP module.

The host module includes a speaker module located in the base 200 for outputting audio content and supporting AI-generated speech synthesis playback; a lighting module embedded in the middle or top section, supporting functions like gradient lighting, mood synchronization, and timed breathing lights; and an identification contact module equipped with magnetic+electronic contact modules at the top for doll identity recognition and data reading.

In the character doll module, the doll is a detachable module with a unique identity recognition chip (NFC/EEPROM, etc.). The chip stores preset character voice parameters, story list indexes, growth status information, and other data. It features playback triggering functionality, automatically initiating story matching and lighting coordination upon insertion.

The AI speech synthesis module includes local or cloud-based calls to specific voice models via character ID, enabling “the character's voice to tell stories.” It supports parents recording to learn voice tones or invoking general anthropomorphic character styles and intonations.

Content Management Module: supports built-in fixed stories, user-uploaded stories, or online AI-generated stories; each story segment can be tagged with “mood markers”to synchronize with the rhythm and color changes of the lighting module.

Pairing and APP Module: supports initial connection pairing (Bluetooth or Wi-Fi), synchronizes story packs and doll data; and can operate offline independently after initial setup.

When a user inserts a character doll, the recognition chip activates to read the character's identity; the system matches the story content and voice style corresponding to the character ID; simultaneously initiates audio output (via AI voice synthesis or pre-recorded tracks) and synchronizes with lighting rhythms; during story playback, lighting color, brightness, or flashing patterns change based on emotional cues; after playback, progress is saved to the doll or local cache for resuming later; all processes can be completed offline, ensuring stability and safety for children's nighttime use.

Applicability for infant sleep training: combines white noise, story guidance, and lighting rhythms; kindergarten soothing companionship: daytime use for interactive storytelling/safety education; family personalization: supports parents uploading stories and mimicking their own voices; future expandability includes character dialogue/dual-doll interaction/smart projection-assisted content output.

In other embodiments (not shown), the sleep aid device for children includes a character recognition module, a microphone module, a voice synthesis module, a lighting feedback module, a local storage module, and a growth record management module.

Role recognition module: located at the top of the device, featuring a plug-in or magnetic structure to identify the doll's identity and corresponding voice parameters. Microphone module: captures user voice input and recognizes activation keywords or wake-up behaviors. Voice synthesis module: calls local or preset voice models to simulate character-specific vocal responses based on role recognition results. Light feedback module: enhances companionship by changing light effects according to speech content and emotional state. Local storage module: integrated with a storage chip (e.g., Micro SD card) for saving all user conversation recordings and metadata (timestamps, role IDs, keywords, etc.). Growth record management module: organizes daily recordings into growth voice stories, which can be uploaded to an APP or accessed by parents via encrypted interfaces, which not only enables role-based voice interaction, strengthening children's emotional projection and trust in the storytelling device but also serves as a “tree hole” function for expressing emotions and inner thoughts; all recordings are stored locally to ensure children's privacy and comply with U.S. COPPA requirements; parents can monitor their child's language expression, emotional patterns, and psychological state changes through the APP; it also supports long-term growth record archiving to create personalized “growth voice story collections.” Additionally, it can expand AI analysis capabilities for more educational and emotional companionship scenarios.

In other embodiments (not shown), the sleep aid device for children internally includes a flexible light source unit, an audio playback unit, a control module, and a power module 105.

The flexible light source unit is positioned on the inner side of the eye mask near the eye area, providing even illumination without direct eye exposure and supporting sunrise/sunset simulation rhythm modes. The audio playback unit, embedded in the ear cushions on both sides of the eye mask, plays white noise, sleep-inducing music, or personalized audio content. The control module includes Bluetooth/Wi-Fi connectivity, programmable timer control, rhythm synchronization logic, and memory functions. The power module 105 uses rechargeable batteries to support extended nighttime use. It delivers fully private, low-interference sleep guidance, improving user sleep efficiency and quality, suitable for adults and shared environments (e.g., partners, business trips, hotels).

In other embodiments (not shown), the lamp body 100 serves as an acquisition terminal, which may be a camera, intercom, camera module, microphone array, or children's watch. The acquisition terminal can collect data related to a child's behavior, emotions, or physiological state. For example, voice, images, or videos: voice records the child's laughter or speech; images capture their movements, demeanor, or expressions; and videos can track continuous actions and expression changes, extracting key frames from them.

Specifically, the data includes at least one of voice data, image data, video data, motion data, environmental parameters, physiological signals, and/or instructions input by external devices. Voice data captures the user's voice; image data photographs the user's movements, expressions, and demeanor; video data records the user's movements, expressions, and demeanor, with keyframes extracted from the video. Motion data, environmental parameters, and physiological signals can all be displayed in image and video data. The audio sampling rate supported by the collection terminal ranges from 16 kHz to 48 kHz, while the image capture speed can be automatically adjusted based on actual scenarios and device power consumption, varying from 1 to 30 frames per second.

It also includes a data processing module and a content generation module. The data processing module is responsible for data communication with the collection terminal, transmitting, preprocessing, or converting the collected data, then sending the processed data to the content generation module. The content generation module receives the data from the data processing module, analyzes emotions, behaviors, or states from voice, image, or video data, generates result information describing emotions, behaviors, or states, and based on this information, user historical data, or preset content templates, creates personalized stories, dialogues, music, or audiovisual content related to the user's state, used for children's emotional soothing, interactive companionship, and sleep assistance.

It also includes a voice output control module, which, based on parental voice feature models, authorized person voice feature models, and AI-generated voice feature models, converts personalized content into voice output matching the corresponding person's voice.

The base 200 serves as the output terminal, integrating an audio module, lighting module, display module, and touch module internally. The audio module communicates with the content generation module, outputting personalized content in at least one form of audio, text, images, lighting, or tactile feedback. The audio module can synchronize with the lighting module, enabling the lighting module to change light effects according to the story's rhythm. The display module can show text and images, while the touch module provides tactile feedback upon touch. The collection terminal and output terminal can adopt a split or integrated structure, and the content generation module and voice output control module can be deployed on the collection terminal, output terminal, or remote server.

In terms of implementation, the content generation module integrates two approaches: a cloud-based AI model and a local embedded AI model, which work individually or collaboratively to perform emotion analysis and story generation tasks. The collection terminal gathers voice, image, or video data related to the child's state, processes it through the data processing module, and sends it to the content generation module. The local embedded AI model in the content generation module first performs preprocessing, analyzing the voice, image, or video data for emotions and behaviors, extracting corresponding semantic labels or textual descriptions. The refined data is then uploaded to the cloud-based AI model for in-depth analysis and story generation. The generated story content is converted into speech and played by the output terminal. When unstable or disconnected network conditions are detected, the local embedded AI model automatically takes over all processing tasks, including story generation and speech conversion, to ensure continuous playback in an offline mode.

Additionally, the collection terminal can intelligently adjust the output modes of the lighting and audio modules based on the user's real-time activity data (such as emotional state or physiological rhythms), enabling a considerate sleep guidance function. The terminal captures the user's voice (tone, speed, laughter, or crying), expressions, and movements (frowning, smiling, turning over, or lying still), removes environmental noise (e.g., TV sounds) and irrelevant visuals (e.g., background clutter), retaining only the user's voice clips, facial expressions, and physiological signals. It then identifies key points from the organized information: voice pitch and speed, smiling or frowning, breathing pace, movement frequency, and speech rate changes. A simple AI model analyzes these features to infer emotions (happy, calm, anxious, or sleepy) and rhythms (awake, about to sleep, or already asleep). By combining emotion and rhythm results—e.g., “anxious voice +fast breathing” indicates anxiety—the system triggers device responses: for anxiety, it plays soothing stories and turns on warm, slow-flashing lights; when sleep is approaching, the story volume lowers, the plot smooths out, and the lights gradually dim.

During data collection, the raw data is first processed by edge-side chips for noise reduction and feature extraction. The processed data is then uploaded to the data processing module via BLE or Wi-Fi Direct. The content generation module follows preset strategies: in online mode, data is uploaded to the cloud-based AI model; in an offline mode, data is processed by the local embedded AI model for inference and generation. The offline mode uses a circular buffer to store data from the past 7 days, encrypted via AES for privacy protection. The local embedded AI model periodically syncs with or clears data from the cloud-based AI model to ensure efficient storage resource utilization.

The data processing module adopts an MCU or SoC architecture with built-in Wi-Fi+BLE dual-mode. It includes an AI co-processing unit (NPU or DSP), and the cloud AI model uses HTTPs/MQTT communication with auto-reconnect. Upon detecting network anomalies, the system automatically switches to the local embedded AI model. The content generation module employs a Transformer-based language model (such as LLaMA, T5, or GPT family) for text generation. Emotion recognition combines CNN+RNN voice emotion recognition networks to identify emotions like happiness, sadness, and anxiety. Rhythm analysis extracts user speech rate and breathing rhythm through acoustic features (tempo, energy spectrum), mapping them to sleep stages.

The lighting module controls color changes based on story rhythm. During calm scenes, the lights warm up and transition slowly; during exciting scenes, they turn cool and flash rapidly. At the story's conclusion, the lights dim and rhythms slow. The module uses an RGB LED array with PWM control chips and includes an audio amplifier (Class D). It communicates with the data processing module via I2C or SPI bus. Synchronization signals are controlled by the “rhythm parameters” output from the AI module. Lighting frequency: 0.5-3 Hz gradient. Audio-light sync delay is kept within ±20 ms.

Both the collection terminal and output terminal feature SD card slots. An inserted SD card stores data collected by the terminal. After data collection, the SD card is transferred from the collection terminal to the output terminal, which generates stories based on the SD card data to complete the sleep plan.

In other embodiments (not shown), the collection terminal includes a recognition module, a growth state collection module, and a content generation module. The terminal collects image data related to the observed child, and the recognition module identifies the target object to generate corresponding theme information. The growth state collection module acquires child interaction behavior or emotion feature data. The content generation module produces personalized sleep-guiding stories based on theme information, child growth state data, and/or preset family relationship data. The output terminal's lighting and audio modules then deliver sleep-inducing light rhythms and voice playback aligned with the story.

The content generation module is configured to use theme information as the story's core element. Based on the child's growth state data, it matches story tones and plot segments from a database that align with the child's current emotions or behavioral tendencies. It also incorporates preset family relationship data to embed specified family member roles into the plot. Finally, it integrates the core element, story tone, plot segments, and family roles to generate personalized story content.

In other embodiments (not shown), to enable the use of voice samples from designated individuals, a voice sample reception module, a voice feature model generation module and a user status information acquisition module are also included. The voice sample reception module collects voice samples from at least one designated guardian, family member, and/or authorized individual; the voice feature model generation module generates corresponding voice feature models based on the samples; the user status information acquisition module obtains feature information or instructions related to the child's status based on the child's voice input, behavioral events, and/or external inputs. The content generation module creates personalized content for emotional soothing, interactive companionship, and/or sleep assistance based on the child's feature information or instructions. The voice output module converts the personalized content into speech using the corresponding individual's voice based on the voice feature model and delivers it via the output terminal in audio and/or other human-machine interaction forms, allowing the user to hear this tailor-made, personalized story narrated in a unique “voice.”

Among these, the voice feature model generation module and content generation module can be deployed on the collection terminal, output terminal, or remote server, with the system supporting both online and offline operation modes.

It is understandable that the voice sample reception module samples 30 seconds to 3 minutes of speech, then extracts core voice features using MFCC+Pitch+Spectrogram. The module constructs a dedicated voice feature model based on the extracted features, employing a Transformer Encoder model to output a 128-dimensional voiceprint vector feature, stored either in a local secure zone or encrypted cloud storage. The voice output module, serving as the core bridge between the content generation module and the audio module, utilizes a Text-to-Speech model (Tacotron2+WaveGlow/HiFi-GAN), supporting real-time generation and cached playback to fulfill the demand for stories narrated in a designated voice. The voice sample reception module also supports dual “cloud+local” operation, ensuring customized voice functionality remains available even in offline environment.

In other embodiments (not shown), the collection terminal is a doll body designed in human, animal, or any object form, providing emotional companionship interaction. The doll body contains an input sensing module, voice collection module, storage module, wireless communication module, power module, and wireless charging module. The input sensing module includes buttons, touch sensors, or motion sensors, triggering data recording on the collection terminal. The voice collection module includes at least one microphone to capture the child's voice, while the storage module saves the child's audio, image, and video data. The wireless communication module connects to the data processing module for data exchange, supporting wireless methods like Bluetooth, Wi-Fi, low-power wireless, UWB, Zigbee, NFC, or infrared.

The doll body can operate independently. When needed, the doll body can connect to the data processing module via the wireless communication module, uploading stored data from the doll body to the data processing module. The content generation module then creates personalized story content, which is output through the terminal. The power module inside the doll body is a battery, providing power to ensure long-lasting operation. The wireless charging module can connect to either the data processing module or a charging base to recharge the doll's battery, extending its runtime.

The doll body also includes an action module, enabling it to perform corresponding movements in sync with the story content, delivering an immersive “sound, light, and motion” storytelling experience. The action module's structure consists mainly of a torso, transmission mechanism, and drive chip. The drive chip receives motion commands from the main control system and uses the transmission mechanism's gearbox and link rod to achieve multi-degree-of-freedom movement. Based on the plot of the personalized story generated by the content generation module, the drive chip controls the transmission mechanism to execute corresponding actions, such as waving or running, by precisely adjusting joint angles and motion trajectories. The action module combines a lightweight metal skeleton with flexible outer materials, ensuring structural durability while enabling lifelike movements for smooth and vivid performances like waving, running, or turning.

In other embodiments (not shown), the doll body can also function as an interactive terminal, integrating a voice sample reception module, voice feature model generation module, user status information acquisition module, content generation module, voice output module, and audio module. The voice sample reception module collects voice samples from at least one designated guardian, which the voice feature model generation module then converts into a corresponding voice feature model. The user status information acquisition module captures the child's voice input, behavioral events, and/or external inputs to derive status-related features or instructions. When the child speaks to the doll or exhibits specific behaviors during interaction, this module translates the data into status-reflective features or commands. The content generation module then creates personalized story content based on the child's status, which the voice output module converts into speech using the guardian's voice model. Finally, the terminal's audio module outputs the speech in the guardian's voice to help the child fall asleep.

Among them, the voice feature model generation module and content generation module can be deployed at any location—interactive terminal, external device, or remote server.

The interactive terminal also includes a voice feature model storage module, which can store at least one voice feature model associated with a virtual character, authorized persona, or AI-generated character. When a child speaks to the doll or exhibits specific behaviors during interaction, the user state information acquisition module captures this data, converting it into state-reflective features or instructions. The content generation module then produces personalized story content linked to the child. The voice synthesis module transforms this content into audio output using the corresponding voice feature or style model, supporting switching or blending between multiple models to enable multi-character narration or emotional expression. The audio module plays the speech to aid in calming the child and facilitating sleep.

The doll also incorporates a dialogue interaction module, generating responses based on real-time user speech input and delivering feedback in a preset character voice. For both story generation and voice synthesis, the content generation module flexibly employs cloud-based or local embedded AI models, enabling not only story narration in designated character voices but also fluid, natural language interaction. The dialogue module uses infrared sensing for proximity detection, a microphone array for sound localization, and built-in IMU sensors to recognize actions like patting or hugging. When hugged, the doll plays soothing audio; when patted, it switches story chapters; and when called, it responds verbally.

All modules are built on mature AI inference and embedded control frameworks (e.g., TensorRT, PyTorch Mobile). Multi-device collaboration (cameras, watches, intercoms, etc.) is supported, with unified access to the main control system.

Stories generated by the doll and dialogue records from the interaction module are preserved, processed by AI algorithms into an electronic growth journal. Parents can connect via a mobile app to view this journal in real time, gaining insights into the child's thoughts and emotional shifts, identifying potential distress early for prevention and intervention. The journal supports timeline-based browsing, auto-tags key emotional moments and high-frequency interactions, and offers scientific parenting guidance.

In other embodiments (not shown), the doll body serves as a physical interaction device, functioning as a virtual character or emotional companion carrier, and features an information identifier representing the character's identity or state. The device is equipped with a screen to display the virtual lifeform's information identifier and status. It also includes a user status information acquisition module, a character status update module, a content generation module, and a content output module. The user status information acquisition module is configured to collect data related to user behavior, interaction time, and/or emotions. The character status update module generates or updates the virtual character's growth stage or emotional state data based on the device's identification information, user interaction data, and/or preset growth rules. The content generation module creates personalized content for child emotional soothing, interactive companionship, and/or sleep assistance based on the virtual character's state and user status information. The content output module delivers the personalized content via audio output and/or other human-machine interaction methods.

The content generation module may be deployed on the physical interaction device, a companion device or a remote server.

The physical interaction device also includes a family expansion management module. When two devices are simultaneously recognized, a marriage event is triggered, generating family relationship data, which can then produce offspring devices. The family expansion management module automatically unlocks new content resources or behavioral traits upon marriage. Offspring devices possess unique identity data linked to their parents. The marriage event can only be triggered after reaching a preset growth stage.

The present invention further provide a sleep aid method for children, which include that following steps: adopting a sleep aid device for children, wherein the device includes a lamp body 100 and a base 200, and the lamp body 100 and the base 200 are detachably connected; a first circuit board 103 and a second circuit board 207 are respectively arranged in the lamp body 100 and the base 200; the first circuit board 103 and the second circuit board 207 are both equipped with a single chip microcomputer 301 and a Bluetooth control module 309 for wireless connection with a mobile phone; a voice control module 305 and a sensor lamp 306 are also installed on the first circuit board 103, an audio playing component is arranged in the base 200, and a plurality of control buttons 203 electrically connected with the second circuit board 207 are installed on the outer surface of the shell 201;
the method includes the following steps:
Step 1, pressing the control button 203 to start the sleep aid device, and the sleep aid device executing the sleep aid program; at the same time, after the sleep aid device is started, the control button 203 automatically entering a self-locking state, so as to prevent children from accidentally touching the control button 203 and causing the sleep aid device to close;
Step 2, using the Bluetooth function of the mobile phone to be connected to the sleep aid device; after the mobile phone is connected to the sleep aid device, regulating the volume and brightness of the sleep aid device through the mobile APP;
Step 3, setting a sleep plan on the mobile app; after the appropriate sleep program is set, locking the sleep aid device by one button or turning off the self-locking of the control button 203 by the mobile phone APP; if it is necessary to adjust the sleep plan, long-pressing one of the control buttons 203 on the base 200 to unlock all the control buttons 203 on the device, and adjusting the light and sound by the control buttons 203, or terminating the sleep planning program; the user can also adjust the sleep plan through the mobile phone APP.
Step 4, the sleep aid device executing the sleep aid planning program;
Step 5, separating the lamp body 100 and the base 200; at the same time, connecting the base 200 to an external power supply through the USB interface 310 for power supply; they can also be separated before the sleep program is executed;
Step 6, placing the lamp body 100 next to the child to aid sleeping, and placing the base 200 at a certain distance away from the child; at the same time, the speaker 206 on the base 200 playing preset music to help children sleep.
Step 7, when the child wakes up and cries, the voice control module 305 monitoring the crying sound, and the single chip microcomputer 301 automatically executing the preset audio or the recorded audio, and then playing it through the speaker 206, thus coaxing the child to continue sleeping.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A sleep aid device for children, comprising:
at least one collection terminal for acquiring data related to a child's state, wherein the data comprises at least one of voice, images, movements, environmental information, physiological signals, and/or instructions input from an external device;
a data processing module configured to transmit, preprocess, and/or format the data;
a content generation module configured to generate personalized content based on the data related to the child's state, wherein the personalized content is configured for emotional soothing, interactive companionship, and/or sleep assistance; and
an output terminal configured to deliver the personalized content in at least one form of audio, images, light effects, vibrations, and/or other human-machine interaction methods;
wherein the content generation module can be deployed on the collection terminal, an output terminal or a remote server, and the system supports operation in online or offline modes.

2. The sleep aid device for children according to claim 1, wherein the content generation module comprises a cloud AI model and a local embedded AI model for performing emotion analysis and story generation tasks separately or collaboratively.

3. The sleep aid device for children according to claim 2, wherein the collection terminal acquires voice, image or video data related to the child's state, and the data is then processed by the data processing module and sent to the content generation module;
the local embedded AI model in the content generation module first performs preprocessing, conducts emotion and behavior analysis on the voice, image or video data to extract semantic tags or textual descriptions, then uploads the refined data to the cloud AI model for deep analysis and story generation, and converts generated story content into voice for playback by the output terminal.

4. The sleep aid device for children according to claim 3, wherein when unstable or disconnected network conditions are detected, the local embedded AI model automatically takes over all processing tasks, comprising story generation and voice conversion, to ensure continuous playback of story content in an offline mode.

5. The sleep aid device for children according to claim 4, wherein the output terminal comprises an audio module and a lighting module;
wherein the audio module communicates with the content generation module to play personalized story content in audio form, while also synchronizing with the lighting module to adjust light effects according to story rhythms.

6. The sleep aid device for children according to claim 1, wherein both the collection terminal and the output terminal are equipped with SD card slots, into which SD cards are inserted to store the data collected by the collection terminal; and
the SD card from the collection terminal can be removed and inserted into the output terminal, and the output terminal then generates stories based on the data on the SD card.

7. The sleep aid device for children according to claim 1, wherein the collection terminal is a doll body that is shaped like a human, animal or any object, providing emotional companionship and interactive experience, the doll body comprising:
an input sensing module comprising buttons, touch sensors or motion sensors for trigger recording;
a sound collection module configured with at least one microphone for capturing the child's voices or emotional expressions;
a storage module configured to store collected audio data, image data and video data; and
a wireless communication module configured for data exchange with the data processing module.

8. The sleep aid device for children according to claim 7, wherein the doll body further comprises:
a power module, comprising a battery for providing power for the doll body; and
a wireless charging module configured to be connected with the data processing module or a charging base to charge the battery.

9. The sleep aid device for children according to claim 8, wherein the doll body further comprises an action module comprising a torso, a transmission mechanism and a drive chip;
wherein the drive chip receives motion commands from a main control system, and multi-degree-of-freedom movement of the doll body is achieved by a gearbox and a link rod of the transmission mechanism.

10. A sleep aid device for children, comprising:
at least one collection terminal configured to obtain data related to behavior, emotions, and/or physiological states of a child, wherein the data comprises at least one of voice, images, movements, environmental information, physiological signals and/or instructions input from an external device;
a data processing module configured to transmit, preprocess, and/or format the data;
a content generation module configured to generate personalized content based on data related to the states of the child for emotional soothing, interactive companionship, and/or sleep assistance;
a voice output control module configured to convert personalized content into speech with corresponding character voices based on a parental voice feature model, an authorized person voice feature model, and/or an AI-generated voice feature model; and
an output terminal configured to output the personalized content in at least one form of audio, images, light effects, vibration, and/or other human-computer interaction methods;
wherein the content generation module and the voice output control module can be deployed at any position of the collection terminal, the output terminal or a remote server, and a system supports operation in online and/or offline modes.

11. The sleep aid device for children according to claim 10, further comprising a voice sample reception module configured to collect voice samples of at least one specified individual and generate a voice feature model corresponding to the specified individual, wherein the voice sample reception module samples 30 seconds to 3 minutes of speech, extracts core voice features through MFCC+Pitch+Spectrogram feature extraction after sampling, and constructs a dedicated voice feature model based on the extracted features, the modeling being based on a Transformer Encoder model, outputting a 128-dimensional voiceprint vector feature; and
the voice output control module serves as a core bridge between the content generation module and an audio module, employing the Text-to-Speech model: Tacotron2+WaveGlow/HiFi-GAN, supporting real-time generation and cached playback, and fulfilling the requirement of narrating personalized stories in a novice of a specified individual.

12. The sleep aid device for children according to claim 11, wherein the content generation module is configured to receive the data sent by the data processing module, perform emotion, behavior or state analysis on voice data, image data or video data, generate descriptive results of emotions, behaviors or states, and generate personalized stories, dialogues, music or audiovisual content related to the states of a user based on result information, user historical data or preset content templates.

13. A sleep aid device for children, comprising:
a voice sample reception module configured to collect voice samples of at least one specified user or an authorized individual;
a voice feature model generation module configured to generate a voice feature model corresponding to the individual based on the voice samples;
a user state information acquisition module configured to obtain feature information or instructions related to states of a child based on voice input, behavioral events and/or external input of the child;
a content generation module configured to generate personalized content for child emotional soothing, interactive companionship, and/or sleep assistance based on the feature information or instructions;
a voice output module configured to convert the personalized content into speech in a voice of the corresponding individual based on the voice feature model; and
an output terminal configured to output the personalized content in audio and/or other human-computer interaction forms;
wherein the voice feature model generation module and the content generation module can be deployed at any position of the output terminal or a remote server, and a system supports operation in online or offline modes.

14. The sleep aid device for children according to claim 13, wherein when a child speaks to the device or exhibits specific behaviors, expressions or actions during companionship of the device, the user state information acquisition module captures the information, converts the information into feature information or instructions reflecting the states of the child, the content generation module generates personalized story content associated with a current state of the child based on the feature information or instructions, and the voice output module converts the personalized content into voice output corresponding to character voices based on a voice feature model of a guardian to be ultimately played by the output terminal in a voice of a specified user or an authorized person to assist the child in falling asleep.

15. A sleep aid device for children, comprising:
a voice feature model storage module configured to store at least one voice feature model associated with virtual characters, authorized persons and/or AI-generated characters;
a user state information acquisition module configured to acquire feature information or instructions related to states of a child based on voice input, behavioral events and/or external input of the child;
a content generation module configured to generate personalized content for emotional soothing, interactive companionship, and/or sleep assistance based on the feature information or instructions;
a voice output module configured to convert the personalized content into voice output corresponding to character voices based on the voice feature model; and
an output terminal configured to output the personalized content in audio and/or other human-machine interaction forms;
wherein the content generation module and the voice output module can be deployed at any position of the output terminal or a remote server, and a system supports operation in online or offline modes.

16. The sleep aid device for children according to claim 15, wherein the voice output module supports switching and joint output between multiple voice feature models;
when the child speaks to the doll body or exhibits specific behaviors during the companionship of the doll body, the user state information acquisition module captures this information, converts the information into feature information or instructions reflecting the states of the child, then the content generation module generates personalized stories related to current emotions or behaviors of the child based on the feature information or instructions of the child; and
the voice output module converts the personalized story content into voices corresponding to a virtual character or an authorized person, and the output terminal plays the voices to assist the child in emotional soothing and falling asleep.
